(19) United States
(12) Patent Application Publication
(10) Pub. No.: US 2024/0270987 A1
(43) Pub. Date: Aug. 15, 2024

(54) COMPOSITIONS COMPRISING AN ASPHALTITE ADDITIVE FOR ADDITIVE MANUFACTURING

(71) Applicant: 3D Systems, Inc., Rock Hill, SC (US)

(72) Inventor: Meisam Shir MOHAMMADI, Rock Hill, SC (US)

(21) Appl. No.: 18/439,042

(22) Filed: Feb. 12, 2024

Related U.S. Application Data
(60) Provisional application No. 63/445,121, filed on Feb. 13, 2023.

(51) Int. Cl. C09D 7/65; B29C 64/118; B29C 64/153; B29K 21/00; B29K 77/00; B29K 105/00; B29K 105/16; B33Y 10/00; B33Y 70/10; C09D 5/03; C09D 177/00

(52) U.S. Cl. CPC C09D 7/65; B33Y 70/10; C09D 5/033; C09D 177/00; B29C 64/118; B29C 64/153; B29K 2021/003; B29K 2077/00; B29K 2105/16; B29K 2105/251; B29K 2995/004; B33Y 10/00

(57) ABSTRACT

Compositions for additive manufacturing applications are described herein which, in some embodiments, provide improved printing properties. In some embodiments, a composition comprises a primary build material in an amount of 10-99.9 wt. % and an asphaltite additive in an amount of up to 6 wt. %, based on the total weight of the composition. In some cases, the asphaltite additive comprises a solid hydrocarbon-based mineral or a solid organic material formed primarily from hydrocarbons and found in an oil-bearing sedimentary basin, such as gilsonite.

### CROSS REFERENCE TO RELATED APPLICATIONS

This application claims priority pursuant to 35 U.S.C. § 119 to U.S. Provisional Patent Application No. 63/445,121, filed Feb. 13, 2023, which is hereby incorporated by reference in its entirety.

### FIELD

The present invention relates to compositions for additive manufacturing and, in particular, to compositions having improved three-dimensional (3D) printing properties.

### BACKGROUND

Three-dimensional (3D) printers and systems employ materials of various kinds to form various 3D objects, articles, or parts in accordance with computer generated files. Such materials can include build materials used to form the objects themselves, as compared to sacrificial support materials which may be used to support an object during the additive manufacturing process but which are subsequently removed from the final printed object. Some build materials are also known as inks, for example in the case of polymerizable liquids or other fluids that are jetted or otherwise selectively deposited to form a 3D object. In some such instances, the build material is solid at ambient temperatures and converts to liquid at elevated jetting temperatures. In other instances, the build material is liquid at ambient temperatures. Build materials can also be powders or dry particulate materials, as opposed to polymerizable liquids. Such powders may be used in selective laser sintering (SLS) and similar additive manufacturing techniques.

Build materials can comprise a variety of chemical species. Chemical species to include in a build material can be selected according to various considerations including, but not limited to, desired chemical and/or mechanical properties of the printed article and operating parameters of the 3D printing apparatus or system. Unfortunately, some build materials and resultant articles printed from the build materials can have undesired solidification behavior, flow behavior (e.g., relatively high viscosity), and/or relatively low resistance to degradation caused by ultraviolet (UV) light, and there is a need for improved materials for additive manufacturing that have improved solidification behavior, reduced viscosity, and/or improved resistance to UV light.

### SUMMARY

In view of the foregoing, compositions (or build materials) for additive manufacturing applications are described herein which, in some embodiments, have solidification behavior and/or flow behavior desirable for additive manufacturing processes. The compositions may also provide improved mechanical or chemical properties to articles formed from the compositions, such as improved resistance to degradation caused by UV light. In some embodiments, a composition described herein comprises a primary build material in an amount of 10-99.9 wt. % and an asphaltite additive in an amount of up to 6 wt. %, based on the total weight of the composition. As described further herein, various asphaltite additives may be used in a composition according to the present disclosure. In some cases, for example, an asphaltite additive described herein comprises a solid hydrocarbon-based mineral (e.g., gilsonite) or a solid organic material formed primarily from hydrocarbons and found in an oil-bearing sedimentary basin. In some instances, an asphaltite additive described herein comprises 50-80 wt. % asphaltenes, 15-40 wt. % resins (such as maltenes), and up to 10 wt. % oils. Additionally, in some embodiments, an asphaltite additive described herein has a weight average molecular weight of 2000 to 4000 g/mol or 2500 to 3500 g/mol.

Further, such an asphaltite additive can be combined with a variety of primary build materials, such as may be used in SLS, fused deposition modeling (FDM), fused granulate modeling (FGM), or other forms of additive manufacturing or 3D printing. For example, in some embodiments, the primary build material of a composition described herein comprises a sinterable powder. Additionally, in some such cases, the sinterable powder comprises a semicrystalline polymer, such as a polyamide (PA), a polyester (PEs), a polyurethane (PU), a polyethyelene (PE), a polypropylene (PP), a poly(butylene terephthalate) (PBT), or a combination of two or more of the foregoing. It is also possible for the sinterable powder to comprise a thermoplastic polymer, such as an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing. Such a sinterable powder as described herein may be particularly suitable for use in SLS.

Moreover, a composition described herein may be used in other methods of 3D printing and is not necessarily limited to SLS. In some embodiments, for instance, a composition described herein comprises, or consists of, or consists essentially of a filament material. In some such cases, the asphaltite additive is dispersed within the primary build material within the filament material. In other cases, a composition described herein comprises, or consists of, or consists essentially of a pellet material. Further, in some such instances, the asphaltite additive is dispersed within the primary build material within the pellet material. Alternatively, in some cases, the pellet material is formed from the primary build material, and the asphaltite additive is physically blended or mixed with the pellet material but is not necessarily dispersed within the pellet material, as may occur by melt-blending for instance.

In another aspect, methods of printing a 3D article are described herein. In some cases, such a method comprises providing a composition described herein and selectively solidifying layers of the composition to form the article. In some implementations, the composition is provided in a layer-by-layer process. Moreover, in some embodiments, selectively solidifying layers of the composition comprises sintering the layers of the composition (e.g., as in an SLS process). In other cases, selectively solidifying layers of the composition comprises depositing the layers of the composition in a molten state and subsequently freezing or partially freezing the layers of the composition (e.g., as may occur in an FDM or FGM process). In still other instances, selectively solidifying layers of the composition can comprise melting and subsequently refreezing or partially refreezing the layers of the composition.

Printed 3D articles or objects are also described in the present disclosure. Such an article or object can be formed from or primarily formed from a composition described herein, including an asphaltite additive.

These and other embodiments are further described in the following detailed description.

### BRIEF DESCRIPTION OF THE DRAWINGS

FIG. 1 illustrates differential scanning calorimetry (DSC) plots for one embodiment of a composition described herein, compared to a comparative composition.

FIG. 2 illustrates DSC plots for one embodiment of a composition described herein, compared to a comparative composition.

### DETAILED DESCRIPTION

Embodiments described herein can be understood more readily by reference to the following detailed description and examples. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” should generally be considered to include the end points 5 and 10.

Further, when the phrase “up to” is used in connection with an amount or quantity, it is to be understood that the amount is at least a detectable or non-zero amount or quantity. For example, a material present in an amount “up to” a specified amount can be present from a detectable or non-zero amount and up to and including the specified amount.

Additionally, in any disclosed embodiment, the terms “substantially,” “approximately,” and “about” may be substituted with “within [a percentage] of” what is specified, where the percentage could be 0.1, 1, 5, or 10 percent, unless the use of such a term in a given instance indicates otherwise.

It is also to be understood that the article “a” or “an” refers to “at least one,” unless the context of a particular use requires otherwise.

The terms “three-dimensional printing system,” “three-dimensional printer,” “printing,” and the like generally describe various solid freeform fabrication techniques for making three-dimensional articles or objects by selective laser sintering (SLS), stereolithography (SLA), dynamic light projection (DLP), selective deposition, jetting, fused deposition modeling (FDM), fused granulate modeling (FGM), multijet modeling (MJM), and other additive manufacturing techniques now known in the art or that may be known in the future that use a build material or ink to fabricate three-dimensional objects.

In one aspect, compositions for use in additive manufacturing applications are described herein. The compositions, for example, can be employed in SLS, FDM, and FGM printing applications. A composition described herein, in some embodiments, comprises a primary build material (e.g., in an amount of 10-99.9 wt. %, based on the total weight of the composition) and an asphaltite additive (e.g., in an amount of up to 6 wt. %, based on the total weight of the composition). Specific components of compositions according to the present disclosure will now be described in further detail.

An asphaltite additive described herein, in some embodiments, can comprise a solid hydrocarbon-based mineral, such as the mineral known as gilsonite, uintaite, or uintahite. Such an asphaltite may be obtained from the Uinta (or Uintah) Basin in Utah, U.S.A. An asphaltite may also be obtained from Iran. Moreover, in some embodiments, an asphaltite additive described herein comprises a solid organic material formed primarily from hydrocarbons and found in an oil-bearing sedimentary basin (e.g., the Uinta Basin or a different basin). In some instances, an asphaltite additive described herein comprises 50-80 wt. % asphaltenes, 15-40 wt. % resins (such as maltenes), and up to 10 wt. % oils (e.g., as determined by Fourier Transform infrared spectrometry (FTIR) and/or nuclear magnetic resonance spectroscopy (NMR)). Additionally, in some embodiments, an asphaltite additive described herein has a weight average molecular weight of 2000 to 4000 g/mol or 2500 to 3500 g/mol.

Further, in some cases, an asphaltite additive described herein comprises a thermoplastic hydrocarbon resin (or a resinous hydrocarbon) that (1) comprises at least 30 wt. % asphaltenes, based on the total weight of the asphaltite; (2) is soluble in an aromatic hydrocarbon solvent (such as toluene, ethylbenzene, or xylene) and/or a chlorinated hydrocarbon solvent (such as carbon tetrachloride, perchloroethylene, or 1,1,1-trichloroethane) and/or (3) has a chemical composition of 82-88 wt. % carbon, 8-12 wt. % hydrogen, 2.5-3.5 wt. % nitrogen, up to 1 wt. % sulfur, up to 2 wt. % oxygen, and up to 0.5 wt. % other elements, based on the total weight of the asphaltite. Additionally, in some cases, the carbon content of an asphaltite additive described herein comprises a majority of aliphatic carbon (e.g., 65-70 wt. % aliphatic carbon, as compared to 30-35 wt. % aromatic carbon).

Further, in some embodiments, an asphaltite additive described herein comprises one, two, three, four, five, or all six of the compositional parameters or features listed in Table 1 below (due to the asphaltite additive's composition and microstructure).

TABLE 1
Compositional Parameters

| Compositional Parameter | Value |
|---|---|
| Softening Point | 125-205° C. |
| Moisture Content | 0.2-0.7 wt. % |
| Ash Content | 0.2-0.7 wt. % |
| Specific Gravity @ 25° C. | 1.01-1.09 |
| Hardness (Moh's) | 1.8-2.2 |
| Glass Transition Temperature (T_{g}) | 80-110° C. |

It is further to be understood that the “softening point” of Table 1 above can be synonymous with a “melting point” of the asphaltite, including because some asphaltites have relatively sharp melting points while others melt more gradually.

An asphaltite additive can be present in a composition described herein in any amount not inconsistent with the technical objectives of the present disclosure. In some embodiments, the asphaltite additive is present in the composition in an amount of 0.1 to 6 wt. %, based on the total weight of the composition. In other cases, an asphaltite additive is present in the composition in an amount of 0.1 to 5 wt. %, 0.1 to 4 wt. %, 0.1 to 3 wt. %, 0.1 to 2 wt. %, 0.1 to 1.5 wt. %, 0.1 to 1 wt. %, 0.5 to 6 wt. %, 0.5 to 5 wt. %, 0.5 to 4 wt. %, 0.5 to 3 wt. %, 0.5 to 2 wt. %, 0.5 to 1.5 wt. %, 0.5 to 1 wt. %, 1 to 6 wt. %, 1 to 5 wt. %, 1 to 4 wt. %, 1 to 3 wt. %, or 1 to 2 wt. %, based on the total weight of the composition. In some preferred embodiments, the asphaltite additive is present in the composition in an amount of less than 3 wt. %, less than 2.5 wt. %, or less than 2 wt. %, based on the total weight of the composition.

Turning now to the primary build material of a composition described herein, it is to be understood that a variety of primary build materials may be used. Additionally, the primary build material can be selected based at least in part on the method of additive manufacturing. In general, a composition described herein can be used for additive manufacturing comprising sintering (e.g., SLS), adhesive fusion of particles, and/or fused deposition of material (e.g., FDM using filaments or FGM using pellets).

Thus, in some embodiments, the primary build material of a composition described herein comprises a sinterable powder. As understood by a person of ordinary skill in the art, a “sinterable” powder can be selectively sintered or fused by application of energy, such as provided by a laser beam or other source of electromagnetic radiation. The application of energy (e.g., a selectively applied laser beam) can selectively heat powder particles, with the result that the powder partially melts and adjacent particles fuse with one another. “Sintering” can thus in some cases include the heating of the powder to a temperature which causes viscous flow only at contiguous boundaries of the individual powder particles, with at least some portion of substantially all particles remaining solid. As described above, such sintering can cause coalescence of particles into a sintered solid mass, the bulk density of which is increased compared to the bulk density of the powder particles before they were sintered. Such fusing can provide a solidified portion (e.g., a cross-section or layer) of an article or object being printed or formed by the process. An article or object formed by layer-by-layer or “slice-wise” joining of vertically contiguous layers which are sintered into stacked “layers” or “slices” can thus be described as autogenously densified. Such slices or layers can have a thickness of, for example, up to about 250 μm, such as in the range of 50 μm to 180 μm.

A sinterable powder of the present disclosure can thus have optical properties, thermal properties, and other properties suitable for use with a 3D printing system or method that forms objects by fusing or sintering individual powder particles together in a selective way. For instance, a sinterable powder can have optical (e.g., absorbance) and/or thermal properties (e.g., glass transition temperature, Tg; melting point, MP; or crystallization temperature Tc) selected for sintering with a particular source of electromagnetic radiation. In some embodiments, a sinterable powder described herein has a non-zero absorbance or an absorbance peak at the wavelength used in the 3D printing process (e.g., at the peak wavelength of the laser, such as a CO₂ laser, used in an SLS process). Moreover, in some cases, a sinterable powder described herein has a sintering window (defined as the metastable thermodynamic region between melting and crystallization, or the difference between the MP onset and Tc onset) of at least 10° C., such as a sintering window of 10-30° ° C., 10-25° C., or 10-20° ° C., when measured by differential scanning calorimetry (DSC). Additionally, in some instances, a sinterable powder described herein has an MP of 120-270° C., 150-250° C., 150-200° ° C., 150-180° C., 170-250° C., 170-220° ° C., 170-200° ° C., 190-250° C., 190-220° C., or 200-250° C.

Additionally, in some cases, a sinterable powder can have an average particle size and a flowability suitable for use in such an additive manufacturing method. For example, in some embodiments, a sinterable powder described herein has an average particle size (D₅₀) of 60-300 μm, 60-250 μm, 60-200 μm, 60-150 μm, 60-100 μm, 80-300 μm, 80-250 μm, 80-200 μm, 80-150 μm, 80-100 μm, 100-300 μm, 100-250 μm, 100-200 μm, 150-300 μm, 150-250 μm, 150-200 μm, 200-300 μm, or 200-250 μm. A sinterable powder described herein, in some implementations, has a monomodal particle size distribution (PSD), as opposed to a bimodal or other higher order PSD. Further, in some cases, a sinterable powder described herein has a normalized packing density of 20-45% or 25-40%. Moreover, in some embodiments, a sinterable powder described herein has an average roundness (defined as the ratio between the measured area of a particle and the area of an equivalent circle with the maximum length of the particle as diameter) of 0.4 to 0.6. Moreover, in some embodiments, a sinterable powder described herein has a bulk density and/or a tap (or tapped or tamped) density above 0.35 g/mL or above 0.4 g/mL, such as a bulk and/or tap (or tapped or tamped) density between 0.35 and 1 g/mL or between 0.4 and 1 g/mL, when measured in accordance with ASTM D1895B (bulk density) or ASTM B527 (tap density).

It is further to be noted that, in some cases, an asphaltite additive described herein does not significantly alter the sintering window of a sinterable powder described herein. For example, in some cases, the sintering window of a composition including an asphaltite additive described herein has a width (in degrees Celsius) and/or one or more end points (in degrees Celsius) that is within 1° C., within 2° C., or within 5° C. of an otherwise similar composition that does not include the asphaltite additive. Moreover, in some instances, a composition described herein that comprises the asphaltite additive does not smoke or generate smoke when heated by a laser or other source of heat in an additive manufacturing process, such as described herein. Thus, in some embodiments, carrying out a method described herein does not generate smoke observable to a human observer having average visual acuity when observing the method without any instruments or visual aids other than corrective lenses such as glasses or contact lenses.

Any sinterable powder not inconsistent with the objectives of the present disclosure may be used. In some cases, the sinterable powder comprises a semicrystalline polymer, including in some instances as a primary or majority component (by mass or weight) of the sinterable powder. Any semicrystalline polymer not inconsistent with the objectives of the present disclosure may be used. In some implementations, the sinterable powder of a composition described herein comprises (or primarily comprises as the majority component) a polyamide (PA), a polyester (PEs), a polyurethane (PU), a polyethyelene (PE), a polypropylene (PP), a poly(butylene terephthalate) (PBT), or a combination of two or more of the foregoing. When the sinterable powder comprises a polyamide (PA), any PA not inconsistent with the objectives of the present disclosure may be used. For example, in some cases, the PA comprises polyamide-11 (PA 11), polyamide-12 (PA 12), or a combination of PA 11 and PA 12.

In some cases, a sinterable powder described herein comprises up to 100 wt. %, up to 99 wt. %, up to 95 wt. %, or up to 90 wt. % semicrystalline polymer, based on the total weight of the sinterable powder (not based on the total weight of the overall composition). In some instances, the sinterable powder comprises 50-100 wt. %, 50-99 wt. %, 50-90 wt. %, 50-80 wt. %, 50-70 wt. %, 60-100 wt. %, 60-99 wt. %, 60-90 wt. %, 70-100 wt. %, 70-99 wt. %, 70-90 wt. %, 80-100 wt. %, 80-99 wt. %, 80-95 wt. %, 85-100 wt. %, 85-99 wt. %, 85-95 wt. %, 90-100 wt. %, or 90-99 wt. % semicrystalline polymer, based on the total weight of the sinterable powder.

Additionally, in some embodiments, a sinterable powder described herein comprises a thermoplastic polymer (e.g., instead of or in addition to a semicrystalline polymer). Moreover, the thermoplastic polymer can comprise any thermoplastic polymer not inconsistent with the technical objectives of the present disclosure. For example, in some cases, the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

In some cases, a sinterable powder described herein comprises up to 100 wt. %, up to 99 wt. %, up to 95 wt. %, or up to 90 wt. % thermoplastic polymer, based on the total weight of the sinterable powder (not based on the total weight of the overall composition). In some instances, the sinterable powder comprises 50-100 wt. %, 50-99 wt. %, 50-90 wt. %, 50-80 wt. %, 50-70 wt. %, 60-100 wt. %, 60-99 wt. %, 60-90 wt. %, 70-100 wt. %, 70-99 wt. %, 70-90 wt. %, 80-100 wt. %, 80-99 wt. %, 80-95 wt. %, 85-100 wt. %, 85-99 wt. %, 85-95 wt. %, 90-100 wt. %, or 90-99 wt. % thermoplastic polymer, based on the total weight of the sinterable powder.

In addition to a primary or majority component such as described above, a sinterable powder described herein can also comprise one or more additional components. In some embodiments, for instance, the sinterable powder comprises a filler material. Any filler material not inconsistent with the objectives of the present disclosure may be used. For example, in some cases, the filler material comprises glass, ceramic, or carbon fiber. In some embodiments, the filler material is in the form of spheres, plates, or fibers, and the shape of any filler material is not particularly limited.

A filler material, if used, can be present in the sinterable powder in any amount not inconsistent with the technical objectives of the present disclosure. For example, in some cases, a sinterable powder described herein comprises up to 30 wt. %, up to 20 wt. %, up to 15 wt. %, or up to 10 wt. % filler material, based on the total weight of the sinterable powder (not based on the total weight of the overall composition). In some instances, the sinterable powder comprises 1-30 wt. %, 1-25 wt. %, 1-20 wt. %, 1-15 wt. %, 1-10 wt. %, 1-5 wt. %, 5-30 wt. %, 5-25 wt. %, 5-20 wt. %, 5-15 wt. %, or 5-10 wt. % filler material, based on the total weight of the sinterable powder.

A sinterable powder described herein may also comprise a flowing agent. Any flowing agent not inconsistent with the technical objectives of the present disclosure may be used. For example, in some cases, a flowing agent comprises a nanoparticulate coating or other coating on the sinterable powder or on a semicrystalline polymer of the sinterable powder, such as a silica nanoparticle coating. One example of a flowing agent suitable for use in some embodiments described herein is Aerosil 200.

A flowing agent, if used, can be present in the sinterable powder in any amount not inconsistent with the technical objectives of the present disclosure. For example, in some cases, a sinterable powder described herein comprises up to 10 wt. %, up to 5 wt. %, up to 1 wt. %, or up to 0.5 wt. % flowing agent, based on the total weight of the sinterable powder (not based on the total weight of the overall composition). In some instances, the sinterable powder comprises 0.01-10 wt. %, 0.01-5 wt. %, or 0.01-1 wt. % flowing agent, based on the total weight of the sinterable powder.

As described hereinabove, a composition described herein does not necessarily comprise a sinterable powder. In some embodiments, a composition described herein comprises, or consists of, or consists essentially of a filament material, such as may be used for FDM applications. Moreover, in some instances, the asphaltite additive is dispersed within the primary build material within the filament material. That is, the filament material can be formed from a blend or combination of the primary build material and the asphaltite additive. Similarly, in some implementations, a composition described herein comprises, or consists of, or consists essentially of a pellet material, such as may be used for FGM applications. In some such embodiments, the asphaltite additive is dispersed within the primary build material within the pellet material. In other words, in some cases, the pellet material is formed from a blend or combination of the primary build material and the asphaltite additive. Alternatively, in other instances, the pellet material is formed from the primary build material, and the asphaltite additive is physically blended or mixed with the pellet material but is not necessarily dispersed within the pellet material (which dispersion may occur by melt-blending for example).

It is further to be understood that, when a sinterable powder is not present or not necessarily present in the composition, the primary build material of the composition can nevertheless comprise a semicrystalline polymer and/or a thermoplastic polymer described hereinabove in the context of sinterable powders. For example, in some cases, a composition described herein comprises, or consists of, or consists essentially of a pellet material (or filament), and the pellet material (or filament) comprises a primary build material which comprises a semicrystalline polymer (e.g., a polyamide (PA), a polyester (PEs), a polyurethane (PU), a polyethyelene (PE), a polypropylene (PP), a poly(butylene terephthalate) (PBT), or a combination of two or more of the foregoing) and/or a thermoplastic polymer (e.g., an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing).

In addition, it is further to be understood that a “primary” build material described herein is not necessarily present in the composition in an amount greater than 50 wt. % of the total weight of the composition. Instead, it is to be understood that the primary build material is the primary or majority material that is (a) combined with the asphaltite additive as a “base” or “carrier” of the additive to form the overall composition, and (b) that is still present in the printed article or object after the additive manufacturing process is complete (as compared, for example, to a sacrificial support material). However, in some preferred embodiments, the primary build material is present in the composition in an amount of at least 50 wt. %, based on the total weight of the composition. In some cases, the primary build material is present in the composition in an amount of 20-99.9 wt. %, 20-99 wt. %, 20-98 wt. %, 20-95 wt. %, 20-90 wt. %, 20-85 wt. %, 20-80 wt. %, 20-75 wt. %, 20-70 wt. %, 20-60 wt. %, 20-50 wt. %, 20-40 wt. %, 30-99.9 wt. %, 30-99 wt. %, 30-98 wt. %, 30-95 wt. %, 30-90 wt. %, 30-85 wt. %, 30-80 wt. %, 30-75 wt. %, 30-70 wt. %, 30-60 wt. %, 30-50 wt. %, 30-40 wt. %, 40-99.9 wt. %, 40-99 wt. %, 40-98 wt. %, 40-95 wt. %, 40-90 wt. %, 40-85 wt. %, 40-80 wt. %, 40-75 wt. %, 40-70 wt. %, 40-60 wt. %, 40-50 wt. %, 50-99.9 wt. %, 50-99 wt. %, 50-98 wt. %, 50-95 wt. %, 50-90 wt. %, 50-85 wt. %, 50-80 wt. %, 50-75 wt. %, 50-70 wt. %, 50-60 wt. %, 60-99.9 wt. %, 60-99 wt. %, 60-98 wt. %, 60-95 wt. %, 60-90 wt. %, 60-85 wt. %, 60-80 wt. %, 60-75 wt. %, 60-70 wt. %, 70-99.9 wt. %, 70-99 wt. %, 70-98 wt. %, 70-95 wt. %, 70-90 wt. %, 70-85 wt. %, 70-80 wt. %, 80-99.9 wt. %, 80-99 wt. %, 80-98 wt. %, 80-95 wt. %, 80-90 wt. %, 90-99.9 wt. %, 90-99 wt. %, 90-98 wt. %, 90-95 wt. %, 95-99.9 wt. %, 95-99 wt. %, or 95-98 wt. %, based on the total weight of the composition.

A composition described herein can be formed or made in any manner not inconsistent with the technical objectives of the present disclosure. For example, in some cases, a composition described herein is formed by mixing or blending the various components together, with or without heating. In some embodiments, a composition described herein is formed by melt-blending or extrusion.

In addition to compositions for additive manufacturing, methods of additive manufacturing are also described herein. Such methods of forming or printing a 3D article, object, or part can include forming the 3D article from a plurality of layers of composition described herein, as a build material, including in a layer-by-layer manner or process. For example, in some instances, a method of printing a 3D article described herein comprises providing a composition described hereinabove and selectively solidifying layers of the composition to form the article. Any composition described hereinabove may be used. Further, the layers of a composition can be formed or provided according to a digital file or image of the article, such as according to preselected computer aided design (CAD) parameters.

In some embodiments, as stated previously, such methods can include SLS or other sintering methods. An SLS method, as understood by one of ordinary skill in the art, can comprise retaining a composition described herein in a container (such as a build bed or powder bed) and selectively applying energy to the composition in the container to solidify (or consolidate or sinter) at least a portion of a layer of the composition, thereby forming a solidified (or consolidated or sintered) layer that defines a cross-section of the 3D article. Additionally, a method described herein can further comprise raising or lowering the solidified layer of the composition to provide a new or second layer of unsolidified composition at the surface of the composition in the container, followed by again selectively applying energy to the composition in the container to solidify (or consolidate or sinter) at least a portion of the new or second layer of the composition to form a second solidified layer that defines a second cross-section of the 3D article. Further, the first and second cross-sections of the 3D article can be bonded or adhered to one another in the z-direction (or build direction corresponding to the direction of raising or lowering recited above) by the application of the energy for solidifying (or consolidating or sintering) the composition. Moreover, selectively applying energy to the composition in the container can comprise applying electromagnetic radiation having a sufficient energy to solidify (or consolidate or sinter) the composition. In some instances, the electromagnetic radiation has an average wavelength of 300-1500 nm. In some cases, the solidifying (or consolidating or sintering) radiation is provided by a computer controlled laser beam. In addition, in some cases, raising or lowering a solidified layer of composition is carried out using an elevator platform disposed in the container. A method described herein can also comprise planarizing a new layer of the composition provided by raising or lowering an elevator platform, or rolling out a new layer of the composition. Such planarization or rolling can be carried out, in some cases, by a wiper or roller.

It is further to be understood that the foregoing process can be repeated a desired number of times to provide the 3D article. For example, in some cases, this process can be repeated “n” number of times, wherein n can be up to about 100,000, up to about 50,000, up to about 10,000, up to about 5000, up to about 1000, or up to about 500. Thus, in some embodiments, a method of printing a 3D article described herein can comprise selectively applying energy to a composition in a container to solidify (or consolidate or sinter) at least a portion of an nth layer of the composition, thereby forming an nth solidified layer that defines an nth cross-section of the 3D article, raising or lowering the nth solidified layer of the composition to provide an (n+1)th layer of unsolidified composition at the surface of the composition in the container, selectively applying energy to the (n+1)th layer of the composition in the container to solidify at least a portion of the (n+1)th layer of the composition to form an (n+1)th solidified layer that defines an (n+1)th cross-section of the 3D article, raising or lowering the (n+1)th solidified layer of the composition to provide an (n+2)th layer of unsolidified composition at the surface of the composition in the container, and continuing to repeat the foregoing steps to form the 3D article. Further, it is to be understood that one or more steps of a method described herein, such as a step of selectively applying energy to a layer of composition, can be carried out according to a digital file or image of the desired 3D article, such as according to preselected CAD parameters or other parameters in a computer-readable format.

Thus, in some embodiments, a method of printing a 3D article described herein comprises providing a composition described hereinabove and selectively solidifying layers of the composition to form the article. Moreover, in some cases, the composition is provided in a layer-by-layer process. In some cases, the method is an SLS or other particle sintering method of additive manufacturing.

Compositions and methods described herein are not necessarily limited to selective laser sintering (SLS) or other sintering applications or uses. The present disclosure also contemplates compositions and methods of forming articles using other additive manufacturing techniques. For example, in some instances, compositions and methods for fused deposition modeling (FDM) or fused granulate modeling (FGM) are also described. In such embodiments, the sinterable powder described above can be replaced with a different material, such as a thermoplastic polymer that can be extruded, jetted, or otherwise deposited (e.g., from a filament or pellets/granules) in a layer-by-layer manner to form a 3D article.

Such a composition as described above can be used in material deposition methods of additive manufacturing, such as FDM or FGM. In a material deposition method, one or more layers of a composition described herein are selectively deposited onto a substrate as a build material and solidified. Solidifying, in some cases, comprises rapid cooling of the composition or the composition's undergoing of a phase transition (e.g., from liquid to solid).

Thus, in some instances, a composition (or build material) described herein is selectively deposited in a fluid or molten state onto a substrate, such as a build pad of a 3D printing system. Selective deposition may include, for example, depositing the build material according to a digital file or image of the desired 3D article, such as according to preselected CAD parameters or other parameters in a computer-readable format. For example, in some embodiments, a CAD file drawing (or other digital image or file) corresponding to a desired 3D article to be printed is generated and sliced into a sufficient number of horizontal slices. Then, the build material is selectively deposited, layer by layer, according to the horizontal slices of the CAD file drawing (or other digital image or file) to print the desired 3D article. A “sufficient” number of horizontal slices is the number necessary for successful printing of the desired 3D article, e.g., to produce it accurately and precisely.

Further, in some embodiments, a preselected amount of build material described herein is heated to the appropriate temperature and extruded or expelled from a nozzle or print head or a plurality of nozzles or print heads of a suitable printer to form a layer on a print pad in a print chamber. For instance, the build material can be in the form of a filament (e.g., on a spool) that is heated and extruded or expelled (e.g., as in FDM); or the build material can be in the form of pellets or granules that are heated and extruded or expelled (e.g., as in FGM). Additionally, in some cases, each layer of build material is deposited according to preselected CAD parameters or other preselected parameters based on a digital file, image, or model of the desired article. As stated above, in some embodiments, a composition (or build material) described herein exhibits a phase change upon deposition and/or solidifies upon deposition. Moreover, in some cases, the temperature of the printing environment can be controlled so that the deposited portions of build material solidify on contact with the receiving surface. Additionally, in some instances, after each layer is deposited, the deposited material is planarized prior to the deposition of the next layer. Optionally, several layers can be deposited before planarization. Planarization corrects the thickness of one or more layers by evening the dispensed material to remove excess material and create a uniformly smooth exposed or flat up-facing surface on the support platform of the printer. In some embodiments, planarization is accomplished with a wiper device, such as a roller, which may be counter-rotating in one or more printing directions but not counter-rotating in one or more other printing directions. In some cases, the wiper device comprises a roller and a wiper that removes excess material from the roller. Further, in some instances, the wiper device is heated. It should be noted that the consistency of the deposited build material described herein, in some embodiments, should desirably be sufficient to retain its shape and not be subject to excessive viscous drag from the planarizer. Layered deposition of the build material can be repeated until the 3D article has been formed.

Compositions and methods (e.g., SLS, FDM, or FGM methods) described herein can form 3D articles that, in some embodiments, exhibit resistance to degradation by UV light (due to their composition and microstructure). Moreover, in some cases, compositions and methods described herein can be used to provide 3D articles that also have desirable mechanical properties.

These foregoing embodiments are further illustrated in the following non-limiting examples.

### EXAMPLES

Tables 2 and 3 provide formulations of compositions according to some embodiments described herein. Both DuraForm PA and DuraForm HST comprise polyamide and are commercially available from 3D Systems, Inc. The amounts listed in Table 2 are weight percents, based on the total weight of the composition. Dashes (--) indicate a certain component was not used. “Comp.” identifies comparative examples.

TABLE 2
Compositions

| | Sinterable Powder | Asphaltite Additive |
|---|---|---|
| Example 1 | 98 | 2 |
| Example 2 | 98 | 2 |
| Comp. Example 1 | 100 | — |
| Comp. Example 2 | 100 | — |

TABLE 3
Compositions

| | Sinterable Powder | Asphaltite Additive |
|---|---|---|
| Example 1 | DuraForm PA | gilsonite |
| Example 2 | DuraForm HST | gilsonite |
| Comp. Example 1 | DuraForm PA | — |
| Comp. Example 2 | DuraForm HST | — |

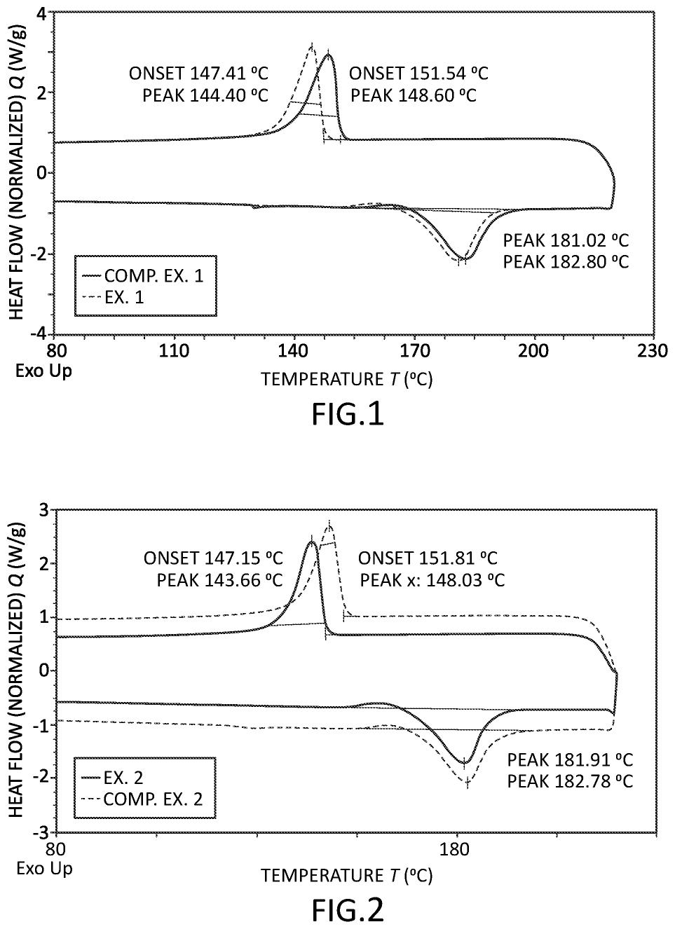

Solidification behavior of Examples 1 and 2 and Comparative Examples 1 and 2 are provided in Table 4. In addition, FIGS. 1 and 2 illustrate differential scanning calorimetry (DSC) plots for the Examples and Comparative Examples. Specifically, FIG. 1 illustrates DSC plots for Example 1 (lighter line) and Comparative Example 1 (darker line). FIG. 2 illustrates DSC plots for Example 2 (darker line) and Comparative Example 2 (lighter line).

TABLE 4
Composition Behavior

| | First Transition | First Transition | Second Transition |
|---|---|---|---|
| | Onset | Peak | Peak |
| | (° C.) | (° C.) | (° C.) |
| Example 1 | 147.41 | 144.40 | 181.02 |
| Comp. Example 1 | 151.54 | 148.60 | 182.80 |
| Example 2 | 147.15 | 143.66 | 181.91 |
| Comp. Example 2 | 151.81 | 148.03 | 182.78 |

Some additional non-limiting example embodiments are described below.

Embodiment 1. A composition for additive manufacturing comprising:
a primary build material in an amount of 10-99.9 wt. %, based on the total weight of the composition; and
an asphaltite additive in an amount of up to 6 wt. %, based on the total weight of the composition.

Embodiment 2. The composition of Embodiment 1, wherein the asphaltite additive has a chemical composition of 82-88 wt. % carbon, 8-12 wt. % hydrogen, 2.5-3.5 wt. % nitrogen, up to 1 wt. % sulfur, up to 2 wt. % oxygen, and up to 0.5 wt. % other elements, based on the total weight of the asphaltite.

Embodiment 3. The composition of Embodiment 1 or Embodiment 2, wherein the asphaltite additive has a weight average molecular weight of 2000 to 4000 g/mol.

Embodiment 4. The composition of any of the preceding Embodiments, wherein the asphaltite additive has a Moh's hardness of 1.8-2.2.

Embodiment 5. The composition of any of the preceding Embodiments, wherein the asphaltite additive has a softening point of 125-205° C.

Embodiment 6. The composition of any of the preceding Embodiments, wherein the asphaltite additive is present in the composition in an amount of 0.1 to 6 wt. %, based on the total weight of the composition.

Embodiment 7. The composition of any of the preceding Embodiments, wherein the asphaltite additive is present in the composition in an amount of less than 2 wt. %, based on the total weight of the composition.

Embodiment 8. The composition of any of the preceding Embodiments, wherein the primary build material comprises a sinterable powder.

Embodiment 9. The composition of Embodiment 8, wherein the sinterable powder comprises a semicrystalline polymer.

Embodiment 10. The composition of Embodiment 8, wherein the sinterable powder comprises a polyamide (PA), a polyester (PEs), a polyurethane (PU), a polyethyelene (PE), a polypropylene (PP), a poly(butylene terephthalate) (PBT), or a combination of two or more of the foregoing.

Embodiment 11. The composition of any of Embodiments 8-10, wherein the sinterable powder comprises a polyamide.

Embodiment 12. The composition of Embodiment 8, wherein the sinterable powder comprises a thermoplastic polymer.

Embodiment 13. The composition of Embodiment 12, wherein the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

Embodiment 14. The composition of any of Embodiments 8-13, wherein the sinterable powder comprises a filler material.

Embodiment 15. The composition of any of Embodiments 1-7, wherein the composition comprises or consists of or consists essentially of a filament material.

Embodiment 16. The composition of Embodiment 15, wherein the asphaltite additive is dispersed within the primary build material within the filament material.

Embodiment 17. The composition of Embodiment 15 or Embodiment 16, wherein the primary build material comprises a semicrystalline polymer.

Embodiment 18. The composition of Embodiment 17, wherein the semicrystalline polymer comprises a polyamide (PA), a polyester (PEs), a polyurethane (PU), a polyethyelene (PE), a polypropylene (PP), a poly(butylene terephthalate) (PBT), or a combination of two or more of the foregoing.

Embodiment 19. The composition of Embodiment 17 or Embodiment 18, wherein the semicrystalline polymer comprises a polyamide.

Embodiment 20. The composition of Embodiment 15 or Embodiment 16, wherein the primary build material comprises a thermoplastic polymer.

Embodiment 21. The composition of Embodiment 20, wherein the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

Embodiment 22. The composition of any of Embodiments 1-7, wherein the composition comprises or consists of or consists essentially of a pellet material.

Embodiment 23. The composition of Embodiment 22, wherein the asphaltite additive is dispersed within the primary build material within the pellet material.

Embodiment 24. The composition of Embodiment 22 or Embodiment 23, wherein the primary build material comprises a semicrystalline polymer.

Embodiment 25. The composition of Embodiment 24, wherein the semicrystalline polymer comprises a polyamide (PA), a polyester (PEs), a polyurethane (PU), a polyethylene (PE), a polypropylene (PP), a poly(butylene terephthalate) (PBT), or a combination of two or more of the foregoing.

Embodiment 26. The composition of Embodiment 24 or Embodiment 25, wherein the semicrystalline polymer comprises a polyamide.

Embodiment 27. The composition of Embodiment 22 or Embodiment 23, wherein the primary build material comprises a thermoplastic polymer.

Embodiment 28. The composition of Embodiment 27, wherein the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

Embodiment 29. A method of printing a three-dimensional article comprising:
providing a composition according to any of Embodiments 1-28; and
selectively solidifying layers of the composition to form the article.

Embodiment 30. The method of Embodiment 29, wherein the composition is provided in a layer-by-layer process.

Embodiment 31. The method of Embodiment 29 or Embodiment 30, wherein selectively solidifying layers of the composition comprises sintering the layers of the composition.

Embodiment 32. The method of Embodiment 29 or Embodiment 30, wherein selectively solidifying layers of the composition comprises depositing the layers of the composition in a molten state and subsequently freezing or partially freezing the layers of the composition.

Embodiment 33. The method of Embodiment 29 or Embodiment 30, wherein selectively solidifying layers of the composition comprises melting and subsequently refreezing or partially refreezing the layers of the composition.

Embodiment 34. A printed three-dimensional article formed from the composition of any of Embodiments 1-28.

All patent documents referred to herein are incorporated by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A composition for additive manufacturing comprising:
a primary build material in an amount of 10-99.9 wt. %, based on the total weight of the composition; and
an asphaltite additive in an amount of up to 6 wt. %, based on the total weight of the composition.

2. The composition of claim 1, wherein the asphaltite additive has a chemical composition of 82-88 wt. % carbon, 8-12 wt. % hydrogen, 2.5-3.5 wt. % nitrogen, up to 1 wt. % sulfur, up to 2 wt. % oxygen, and up to 0.5 wt. % other elements, based on the total weight of the asphaltite.

3. The composition of claim 2, wherein the asphaltite additive has a weight average molecular weight of 2000 to 4000 g/mol.

4. The composition of claim 3, wherein:
the asphaltite additive has a Moh's hardness of 1.8-2.2; and
the asphaltite additive has a softening point of 125-205° C.

5. The composition of claim 1, wherein the asphaltite additive is present in the composition in an amount of 0.1 to 6 wt. %, based on the total weight of the composition.

6. The composition of claim 1, wherein the asphaltite additive is present in the composition in an amount of less than 2 wt. %, based on the total weight of the composition.

7. The composition of claim 1, wherein the primary build material comprises a sinterable powder.

8. The composition of claim 7, wherein the sinterable powder comprises a semicrystalline polymer.

9. The composition of claim 7, wherein the sinterable powder comprises a polyamide (PA), a polyester (PEs), a polyurethane (PU), a polyethyelene (PE), a polypropylene (PP), a poly(butylene terephthalate) (PBT), or a combination of two or more of the foregoing.

10. The composition of claim 7, wherein the sinterable powder comprises a thermoplastic polymer.

11. The composition of claim 10, wherein the thermoplastic polymer comprises an acrylonitrile butadiene styrene (ABS), a polylactic acid (PLA), a polyethylene terephthalate (PET), a thermoplastic polyurethane (TPU), a nylon, a polycarbonate, or a combination, block copolymer, or melt of two or more of the foregoing.

12. The composition of claim 7, wherein the sinterable powder comprises a filler material.

13. The composition of claim 1, wherein the composition is a filament material.

14. The composition of claim 1, wherein the composition is a pellet material.

15. A method of printing a three-dimensional article comprising:
providing a composition according to claim 1; and
selectively solidifying layers of the composition to form the article.

16. The method of claim 15, wherein the composition is provided in a layer-by-layer process.

17. The method of claim 15, wherein selectively solidifying layers of the composition comprises sintering the layers of the composition.

18. The method of claim 15, wherein selectively solidifying layers of the composition comprises depositing the layers of the composition in a molten state and subsequently freezing or partially freezing the layers of the composition.

19. The method of claim 15, wherein selectively solidifying layers of the composition comprises melting and subsequently refreezing or partially refreezing the layers of the composition.

20. A printed three-dimensional article formed from the composition of claim 1.
